(19) United States
(12) Patent Application Publication
(10) Pub. No.: US 2009/0029771 A1
(43) Pub. Date: Jan. 29, 2009

(54) INTERACTIVE STORY BUILDER

(75) Inventor: STEPHEN DONAHUE, Montreal (CA)

Correspondence Address: PAUL, HASTINGS, JANOFSKY & WALKER LLP, 875 15th Street, NW, Washington, DC, 20005, US

(73) Assignee: MEGA Brands International, S.A.R.L., Luxembourg (CH)

(21) Appl. No.: 12/179,241

(22) Filed: Jul. 24, 2008

Related U.S. Application Data
(60) Provisional application No. 60/951,822, filed on Jul. 25, 2007.

(51) Int. Cl. G06F 17/00

(52) U.S. Cl. 463/31; 463/43; 463/42

(57) ABSTRACT

An embodiment of the present invention provides an interactive system for game playing. A user is provided with access to a website or software application to create a virtual scenario or storyline. The virtual storyline is saved to a storage device that is configured to fit into a game hub. When the storage device is placed in the game hub, the game hub is configured to play the storyline. In accordance with an embodiment of the present invention, the storyline can be displayed locally at the game hub to a user. In an embodiment of the present invention, active toys within a communications range of the game hub can be activated to perform actions in accordance with the storyline when the storyline is played by the game hub. In an embodiment of the present invention, actions performed by active toys are forwarded to the game hub and stored in the storage device in a storyline format for playing on a computing device.

This application claims the benefit of U.S. Provisional Application No. 60/951,822, filed Jul. 25, 2007, which is herein incorporated by reference in its entirety.

### BACKGROUND

1. Field of the Invention

The present invention relates generally to interactive games.

2. Background of the Invention

The variety of games and toys has expanded rapidly with the increased sophistication of robot, computer, and communications technology. For example, through advances in sensor, transducer, and microcontroller devices, robots can mimic humans and animals by performing a variety of actions.

The rapid growth of communications and computer technology has likewise facilitated the development of internet-based games, such as games in which users play each other “over the internet,” that is, participate in a real-time or quasi-real-time game while accessing the internet from different physical locations.

There remains a need, however, for expanded means for creativity and user interaction. For example, although robot toys are often, for convenience, pre-programmed to perform a limited series of tasks that require little or no user input, such predefined tasks necessarily limit the play experience. Likewise, internet games that merely extend the distance over which a game can be played between players may not markedly change the nature of the game experience.

### BRIEF SUMMARY OF THE INVENTION

Embodiments of the present invention involve systems and methods for facilitating an interactive user experience centered on user-created stories or scenarios. The stories can be developed and created through access to internet-based tools provided to the user in accordance with embodiments of the present invention.

Developed stories can be reviewed in a virtual world using a computer and then stored in tokens for use in a physical setting. Information stored in the tokens can be uploaded into a game hub that controls a set of physical characters and objects corresponding to those of the virtual story to act out the story.

In one embodiment of the present invention, an interactive story game provided by a vendor includes an interactive story website that provides tools and elements to a user for building a story online. In one embodiment of the present invention, the website is accessed through a code provided to a user who purchases a product from the vendor that is related to the interactive story game. The product may be a package that includes an interactive physical game, as well as a means to access a website to create virtual stories.

In one aspect of the present invention, the website includes a menu of user-selectable elements that can be customized by the user to build a storyline using a computer or similar tool. In one embodiment of the present invention, the content of the website is coupled to a category of physical toys provided by the vendor. For example, a vendor may deploy a line of action hero toys related to medieval fantasy scenarios, including castles, kings, knights, creatures, and battles. Accordingly, the vendor may provide a website that contains virtual medieval fantasy elements from which the user can build a virtual storyline.

In one aspect of the present invention, the story elements provided to a user include at least one avatar that a user can endow with attributes and powers of the user's choosing.

In one aspect of the present invention, the website provides an interface for the user to build a story based on the selected elements and to play out, or rehearse, the story by viewing it on the computer screen. The website can be configured to allow the user to store the user-created story remotely and/or download the story.

In one embodiment of the present invention, the website is configured to allow trading of stories between users who have permission to access the website. In another embodiment, the website is further configured to allow stories to be built or modified in a collective manner by multiple users having access to a common story.

In an embodiment of the present invention, the interactive story game further includes a customized storage device or set of devices that can be used to store a storyline and then plugged into a physical game hub. In one configuration of the invention, the storage devices are configured to plug into a user's computer and open the interactive story website. The storage device then receives the downloaded interactive story created by the user after the user visits the website. In one embodiment of the present invention, the set of storage devices is arranged as a plurality of different dedicated devices that are each specific to a particular storyline or story element. The storage devices can be configured as USB drives or other common connectable external drives. Each dedicated drive (storage device) in a set of drives can be configured as an icon by a combination of shapes and/or markings to indicate the type of story with which the drive is associated.

In one embodiment of the present invention, each dedicated drive provides interactive access only to a website or portion of a website involving the storyline or story element associated with that drive.

In one embodiment of the present invention, the physical game hub includes a USB port or similar port configured to receive a storage device, such as a USB drive containing a storyline. The storyline can be based on a user-created storyline facilitated by an online website provided by the game hub vendor. In another embodiment the storyline could be a preloaded sample storyline.

The physical game hub is configured to communicate with interactive physical components (also termed “active physical game elements” or “active toys”) of the storyline. In one example, for a given storyline, a plurality of physical components is provided to interact with the game hub. In one embodiment of the present invention, the plurality of physical components correspond in whole or in part to virtual elements of a user-designed storyline downloaded from a website of the game hub vendor. Each active physical game element is configured to receive signals and perform a physical action in response to those signals. In an embodiment of the present invention, the game hub is configured to communicate with the physical game elements wirelessly using an RF or infrared signal. When an active physical game element is within a communications range of the game hub, the hub is triggered to send signals to the active physical game element to perform a set of actions in accordance with instructions provided in a storyline. Accordingly, a user storyline created on the vendor website is performed in whole or part by the interactive game hub in real life.

In accordance with another embodiment of the present invention, an interactive game comprises a method and system for two-way construction of stories. A system for two-way construction of stories can comprise a plurality of active physical game elements that are each in communication with a game hub, wherein each active physical game element is configured to send and receive signals to and from the game hub. The game hub is further configured to receive a storage device that is configured to store story information, which can be downloaded to the hub for operating the active physical game elements, and which story information can be uploaded from the hub to the storage device. At least one active physical game element is configured to perform one or more operations in accordance with instructions received from the game hub. In addition, at least one active physical game element is configured with sensors and/or controls that allow a user to perform an operation using the active game element, wherein information about the operation can be recorded by the active game element and sent to the game hub for storage in the storage device.

Accordingly, in a first path of a method for two-way construction of stories, a user can arrange active physical game elements in a scenario that is recorded and transmitted by the storage device to a website or software application for playing of a virtual version of the user-constructed scenario.

In a second path of the method for two-way construction of stories, a website or self-contained software program is provided to a user for construction of a virtual story that can be displayed on, for example, a computer display, telephone display, video game display, or similar display. A storage device is provided that is configured to store the virtual story and upload the virtual story to the game hub. The game hub is further configured to send signals to one or more of the active game elements, wherein the active game element receiving a signal from the game hub is configured to perform an operation corresponding to an element of the virtual story. Accordingly, a user can design a story using a computer or similar device, in which parts of the story are performed by active physical game elements in communication with the game hub.

In accordance with an embodiment of the present invention, the two-way story construction method and system comprise a means for iterative building of a story. For example, a user can manipulate the active physical game elements wherein a set of actions preformed by the active physical game elements are recorded as a story or used to modify an existing story, which story can be saved in the portable storage device and transmitted the story to a website or software application to play a virtual version of the story in the virtual world, which virtual story can be revised in the virtual world, and sent for further enactment and revisions in the physical world comprising the active physical game elements.

### BRIEF DESCRIPTION OF THE DRAWINGS

FIG. 1 is a schematic diagram that depicts elements of an interactive story game, arranged in accordance with an embodiment of the present invention.

FIG. 2 is a schematic diagram that illustrates features of an exemplary web page used for story creating, according to an embodiment of the present invention.

FIG. 3 is a schematic diagram that illustrates an exemplary story builder screen that is launched when an icon is selected, according to an embodiment of the present invention.

FIG. 4 is a schematic diagram that depicts an exemplary scene builder screen that includes a “create background” icon and “character” icon, according to an embodiment of the present invention.

FIG. 5 is a schematic diagram that depicts a “background” screen that provides a selection of background elements that may be added to a scene by selecting icons corresponding to, for example, mountains, trees and foliage, buildings, and day or night sky, according to an embodiment of the present invention.

FIG. 6 is a schematic diagram that illustrates a screen that allows a user to select active characters for a scene, according to an embodiment of the present invention.

FIG. 7 is a schematic diagram that illustrates an exemplary game hub, according to an embodiment of the present invention.

### DETAILED DESCRIPTION OF THE INVENTION

The present invention relates to games or toys that encompass both the use of computers or similar devices to create and visualize stories or scenarios, as well as electrical, electronic, or electromechanical toys that act out the stories or scenarios based on communications from a central hub. Aspects of the invention are designed so that a user can create a virtual story or scenario using a computer or similar device to access, display, and arrange elements that are provided through a website. The virtual story or scenario can then be mimicked using a physical game hub that controls active toys that correspond to the elements created in the virtual story or scenario. The term “virtual,” as used herein, generally refers to a story or elements of a story that are created using a computer and may be stored in a computer readable medium for display on a computer or similar device. The terms “physical” and “real world” as used herein in connection with a game, story, or elements of a story, refer to play involving three dimensional objects, such as toys, buildings, or scenery, as opposed to use of a computer or similar device that employs a visual display to convey the story to a user.

As used herein, the term “virtual element” refers to an entity such as a character or object depicted in a virtual story. Furthermore, the terms an “active virtual element” or a “virtual toy” both refer to a virtual element that performs an action or series of actions, as opposed to a background object, such as a stationary tree or mountain. In addition, an “active physical toy” refers to a physical object that is configured to perform an action when it receives signals, for example, signals sent from a game hub. Accordingly, in embodiments of the present invention, a game element, for example, a knight or dragon character used in a medieval scenario, may correspond to both a virtual toy that comprises the knight or dragon character in action in a story embodied on a computer screen, and also correspond to an active physical toy that is placed in communications range with the game hub and can perform a set of physical actions in real space.

As used herein, the term “scenario” generally refers to a scene that includes an arrangement of objects within a background, together with a set of actions prescribed for active objects, or “characters.” For example, a scenario may involve a group of knights and kings in battle in the vicinity of a castle. Additionally, the terms “story” and “storyline” are used herein to refer to a series of scenarios that can be embodied as a screen show or video presentation (with or without audio) in a computer screen (i.e., virtual), or embodied in a series of actions performed by one or more physical objects in the vicinity of the central hub. A “story” or “scenario” created in accordance with embodiments of the present invention therefore may involve no written content, but rather is created using predominantly or entirely graphical or other multimedia tools provided through access to a computer software application or website.

In alternative embodiments of the present invention a storybuilder program can be embodied in stand-alone software or in a website that may comprise a series of web pages. In the case of stand-alone software, the storybuilder program is configured for storage in a device that is local to a display used by the user to display the stories created by the story builder program. For example, the stand-alone software could be provided in a portable drive such as a DVD or USB drive, which drive can be inserted into a computer (or handheld display), and thereby cause the computer to show on a computer display the story that is built by the user. In the case where the storybuilder program is embodied in the website, the program may be accessed through the internet, but in general need not be stored locally with respect to the user's computer or other device used to display the story. Unless otherwise indicated in the discussion to follow, aspects of the present invention are described in the case where the storybuilder program is accessed through a website provided by a vendor.

The contents of the story can be stored in various types of computer readable media and displayed or embodied in physical toys using programs and controllers in accordance with embodiments of the present invention. Additionally, a story or scenario may constitute a pre-stored program together with content that may be viewable on a computer, as well as implemented using active toys.

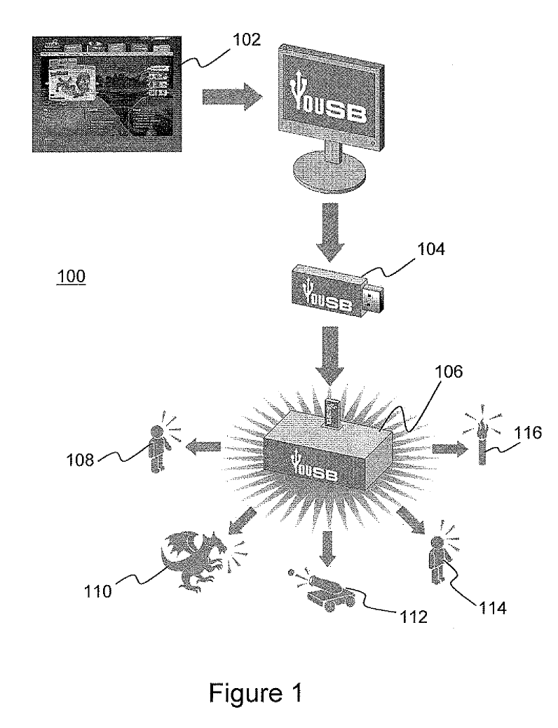

FIG. 1 depicts aspects of an interactive story system 100, arranged in accordance with an embodiment of the present invention. System 100 includes a website 102, storage device (drive) 104, and hub 106. System 100 additionally includes active physical toys 108, 110, 112, 114, and 116. In the discussion to follow, the active physical toys may also be referred to simply as “active toys” or simply “toys,” while active virtual toys are denoted using the term “virtual.”

In an embodiment of the present invention, website 102, storage device 104, hub 106, and toys 108, 110, 112, 114, and 116 are provided as an interactive game product by a vendor. A user who purchases the product can be provided access to website 102 through which a story can be created. The story can then be downloaded and stored in drive 104. In turn, hub 106 is configured to receive drive 104. Drive 104 can be configured as a USB flash drive. The terms “USB drive” and “USB flash drive,” as used herein, refer to a portable storage device that is configured to fit into a standard universal serial bus (USB) connection (pot). The user-created story is then translated into an appropriate format for transmission to active toys 108, 110, 112, 114, and 116, which perform actions in accordance with those prescribed by the user-created story.

The user-created story is interpreted by the game hub, such that the game hub generates electrical signals that are sent to active toys 108-116, which each contain components that enable performance of specified actions. The term “electrical signal,” as used herein, refers to an electromagnetic, AC, or DC signal that is sent between the game hub and active toys.

In an embodiment of the present invention, a user purchasing an interactive story game is provided with a USB drive 104 that is configured to allow the user access to vendor website 102. For example, one implementation of the present invention allows a user to plug the USB drive into a device that is connected to the internet, such as a user's computer that has a USB port for accepting the USB drive, and has a wired or wireless link to the internet. The USB drive contains programs and authentication or other access information that allows a user to access an internet website such as a vendor website accessible through the internet. In one embodiment of the present invention, drive 104 is provided together with toys 108, 110, 112, 114, and 116 as part of a package purchased by a user. For example, active toys 108, 110, 112, 114, and 116 may comprise a set of medieval characters and objects. Drive 104 may include programs and access codes that allow the user to access a medieval game website. Thus, in this example, drive 104 and active toys 108, 110, 112, 114, and 116 can be sold as a “Medieval Hero” interactive game.

In embodiments of the present invention, hub 106 can be sold together with or separate from active toys 108, 110, 112, 114, and 116 and drive 104. Hub 106 may be designed so that it can be used with multiple different stories or scenarios. Thus, once hub 106 is purchased, a user can purchase one or more story sets that each are dedicated to a specific theme, and that each comprise a different set of toys and a corresponding virtual story provided through access to the vendor website using a corresponding USB drive provided with the corresponding set of toys.

In a further aspect of the present invention, hub 106 is one construction element of a toy construction kit containing many different types of stackable, interconnecting construction elements (e.g., MEGA BLOKS® toy construction blocks). For example, in one implementation of the present invention, a toy construction kit includes construction elements for building a castle, a hub 106 configured to be a part of the castle, a number of knight action figures, and a number of dragon action figures. The hub 106 can be, for example, a base plate on which the remaining interconnecting elements (e.g., construction blocks) are stacked to create the castle. When the castle is assembled and the knights and dragons placed around the castle, the hub 106 controls the knights and dragons to perform actions according to the story stored on the drive 104 that is plugged into the hub 106.

Each set of toys and associated USB drive would thereby enable the user to access online, create, view, store, download, and enact a story using the physical toys provided in the set.

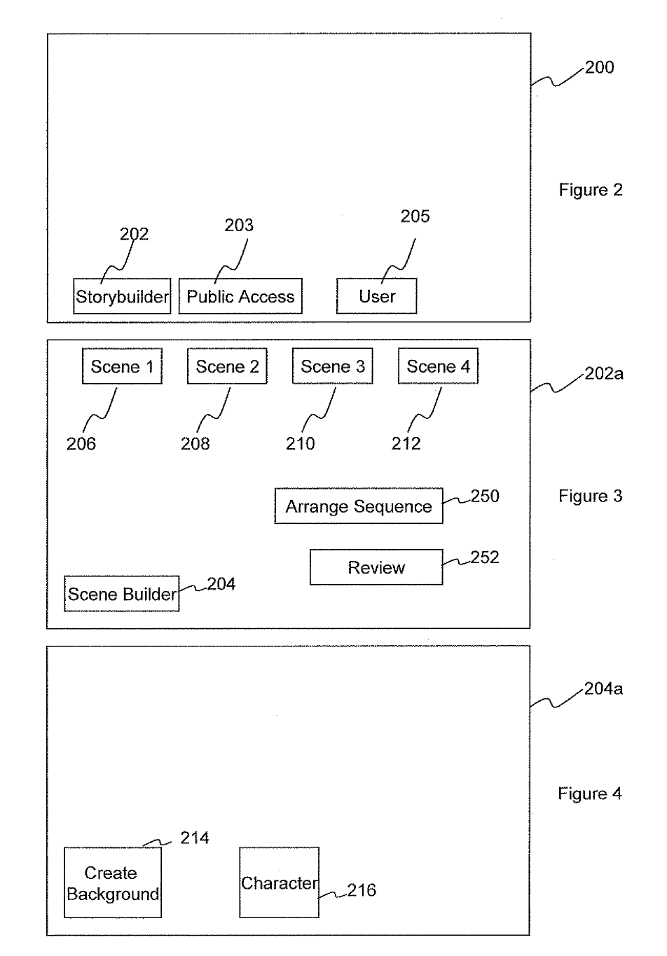

FIG. 2 illustrates features of an exemplary web page 200 used for story creation, in accordance with an embodiment of the present invention. In one embodiment, web page 200 is accessed when a user inserts a USB drive (not shown) into a user computer. For example, the USB drive could provide programs and content that launches the website 200. In one aspect, the program or link to website 200 could be saved to the user computer after an initial use, so that website 200 could be accessed as a “favorite” or other shortcut method whenever the user is online. Depending on the type of product purchased, access to the website could be provided on a temporary or long term basis.

In one embodiment of the present invention, web page 200 is dedicated to a specific theme, storyline, or product line. In other words, web page 200 may comprise an interface to a storybuilder program that involves a medieval heroes theme, in which medieval-based stories and scenarios can be constructed. In one particular example, by purchasing a medieval heroes game, a user is provided with a USB or other drive (such as a CD or DVD) that provides access only to web page 200. Such access could be limited by requiring entry of a code provided with the product for access to a particular website. In another embodiment of the present invention, access to multiple web pages related to multiple storylines could be provided to a user.

In accordance with embodiments of the present invention, web page 200 enables a user to build a virtual world and to create a virtual storyline (or story) in accordance with a specific theme of a purchased product. Web page 200 represents a graphical interface to a program that provides the ability to select and build story elements by the user while online. The program can be configured to display different menus and screens, such that a series of web pages are triggered as the user interacts with the program using a mouse or other selection means. The storyline can be created by a user selecting from a group of elements provided, which can interact with each other and play out designated roles. The user is provided with the ability to choose specific actions for different characters. In the discussion to follow with respect to FIGS. 2-6, an exemplary set of embodiments is discussed that illustrates how a user could build and play a virtual storyline online. However, the figures are merely exemplary, and it is emphasized that many variations are possible in which a user can build an online story.

Web page 200 may include a series of icons or buttons that serve to launch other screens, which may correspond to other web pages, when selected. In the example shown, web page 200 includes story builder icon 202, which may be a graphical icon selectable by a mouse or other indicating device. FIG. 3 illustrates an exemplary story builder screen 202a that is launched when icon 202 is selected. Story builder 202a may comprise a “scene builder” icon or button 204, which launches a user into another screen that allows elements of a scene to be constructed. After creation of a scene, the user may be provided with a button to store the scene. For convenience, stored scenes may be shown in screen 202a as a series of icons 206, 208, 210, and 212.

In one embodiment of the present invention, a storyline can be constructed from a set of preconfigured scenarios. Each scenario may involve a specified set of characters that interact in a prescribed manner. For example, a first scenario might be “knight slays dragon,” a second scenario might be “knight fights knight,” and a third scenario might be “catapult launches attack on castle.” The user could then select from the set of scenarios and construct a storyline that uses the scenarios in any desired order and can repeat the scenarios any amount of times.

In other embodiments of the present invention, scenarios can be constructed by a user by selection of characters and character actions within a given background.

In one embodiment of the present invention, once a user accesses a web page dedicated to a specific storyline, a background containing background elements is automatically provided. The background elements are elements that do not have corresponding active toys associated with the physical hub. For example, in a medieval storyline, a physical hub may be provided with a series of active elements, such as knights, kings, and dragons, which the hub can manipulate to perform actions. Other elements associated with the physical hub are “passive” elements that do not move, emit light or sound, or perform other actions. Such elements might be, for example, trees or a landscape that surround the hub. Accordingly, when constructing a virtual medieval scenario online, the landscape element is provided to a user as a background element. Thus, background elements shown online may correspond to some passive elements that perform no actions, which are provided with the physical toys. Notably, however, background elements depicted online need not have physical counterparts at the physical hub. Thus, an online scene might contain many details that are not emulated in scenery or buildings or other objects associated with the physical hub.

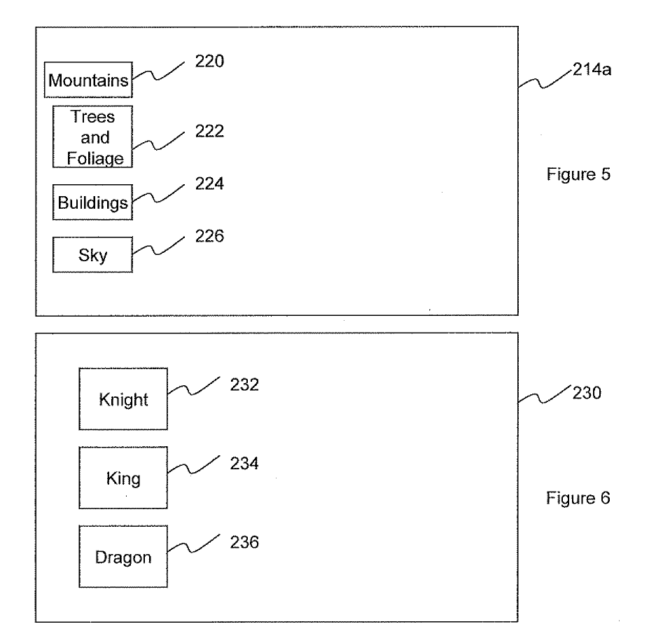

FIG. 4 depicts an exemplary scene builder screen that includes a “create background” icon 214 and “character” icon 216. Icon 214 is selected to allow a user to create background elements of a scene. For example, as depicted in FIG. 5, “background” screen 214a provides a choice of background elements that may be added to a scene by selecting icons corresponding to mountains 220, trees and foliage 222, buildings 224, or day or night sky 226. Although not all of the background elements may have counterparts in the physical game, selection of background elements for display online may add to the user's enjoyment by envisioning different background scenarios when using the physical toys.

Referring again to FIG. 2, if stored-scene icon 206 is selected, a new screen 230 appears that provides icons corresponding to virtual toys, which can be, for example, cannon, or an active character that can perform one or more actions on-screen. The user can select, for example, from a set of icons corresponding to different active characters for the stored-scene, as shown in FIG. 6. For example, icon 232 could correspond to a knight, icon 234 to a king, and icon 236 to a dragon. Once selected, the characters populate a screen that the user has created to create a scenario. Once the elements (virtual toys) of the scenario are selected, the user is provided with a means to select virtual toy action. The virtual toy action could be character action from a set of allowed actions associated with a given character, such as a dragon breathing fire, or a knight slaying a dragon. In addition, the virtual toy action could be a permissible action of a virtual toy that is a machine, such as the firing of a cannon or the launching of a catapult.

In an embodiment of the present invention, a user is provided with an avatar that the user can embody with characteristics that the user chooses. The avatar may be given certain powers or attributes appropriate for the storyline. In addition, the avatar may not have a corresponding physical toy, so that use of the avatar is only for the purposes of acting out a story in the user's computer. In addition, the user could be permitted to create and imbue with desired characteristics any number of additional characters.

In one embodiment of the present invention, the user can build a story using multiple scenarios, such as 206, 208, 210, and 212, which can be arranged in an order according to the users choosing using sequence button 250 of FIG. 3. Alternatively, the story scenes could be automatically saved in accordance with the sequence of their creation. The user is then provided with means to review the story, such as selecting button 252.

In embodiments of the present invention, the scenarios or story can be presented as a set of static pictures. For example, one scenario might involve a series of static pictures that depict a fire-breathing dragon attacking a knight. It will be understood that a single scenario could thereby constitute a story in and of itself. Alternatively, the scenarios can be in video format in which character motion takes place, as in, for example, known video games. In addition, the scenarios can be imbued with appropriate sound effects.

It will be readily appreciated that other means for allowing a user to create online picture or video stories and scenarios involving thematic elements are possible. In accordance with embodiments of the present invention, a common feature is that the user is provided online with the ability to construct a set of scenarios that contain a set of virtual elements and actions associated with those virtual elements. The game hub stores the scenarios (e.g., either copying them from the drive or running them from the drive) and controls the physical elements corresponding to the virtual elements to perform the actions in real life.

In accordance with embodiments of the present invention, once a story is created, the user can save the story either locally to the user's computer or remotely through the designated web page (e.g., stored on the system of the administrator of the designated web page). Preferably, the user is provided with an icon or other button that allows the user to download the created story, for example, to the USB or other drive that is used to launch the website. Alternatively, the website could be configured to automatically save a created story to the user's external drive (USB or DVD).

In one embodiment of the present invention, the user is given the option to store a created story or game publicly, wherein other authorized users accessing a vendor website can have access to the story or game, either for viewing online or for downloading to the other user's game hub. For example, the user could save the story on the vendor's website as a read-only file. Levels of access to other user stories could be controlled in accordance with the type of game package purchased by the user. Access to creating and viewing stories to be shared or provided with other users could be provided, for example, using public access icon 203 depicted in FIG. 2.

In one embodiment, a story could be designated as “read-write” so that other authorized users could access the story and modify it as desired. In this manner, a group of user's could collaborate to create storylines.

In another example, a saved story could be made accessible for other authorized users wherein the story could be modified, saved, and downloaded by any authorized user, while a copy of the original unmodified story remained. Accordingly, users wishing to create a storyline could use a pre-existing story created by another user as a template on which to build or modify a story, rather than building a story from scratch. In one implementation of the invention, a user icon 205 (see FIG. 2) would provide access to the user to user storylines currently stored on the vendor's website.

In addition, means could be provided so that the duration or amount of storage of user-created stories by the vendor is limited.

In accordance with embodiments of the present invention, a means is provided for translating an online user-created storyline into a series of actions that are implemented in physical toys provided to correspond to the storyline. The means can include, for example, a combination of hardware and software that recognizes specific actions performed by designated characters in the storyline and translates these actions into a format that can be transmitted to and interpreted by controllers that control the actions of physical active toys associated with a game hub. Thus, referring again to FIG. 1, when a user creates a storyline, a series of actions corresponding to a series of designated characters is stored as information in an appropriate format in a file and downloaded to the user's drive 104.

By providing a storage device such as a portable drive for storing a virtual story created by a user at a computer, for example, and by providing a game hub that is configured to accept the portable drive, embodiments of the present invention facilitate a flexible play environment. For example, the location for set-up of a game hub for real world enactment of a scenario based on the virtual story is untethered to the location of the computer where the virtual story is created. In other words, a first mode of play, that is, the creation and/or enactment of the virtual story can take place at any location where the user has access to a computer that is enabled by the portable drive or by other means to launch the program/website used for creating the virtual story. A second mode of play, enacting a real world story using active toys (as well as other parts, such as background toys) based on the virtual story, can be performed in any location where the user desires to set up the game hub.

This flexibility in location of play environments occurs because the relevant information from the virtual story that is used for operation of the active toys can be downloaded to the portable drive, which can then be placed in the game hub at any desired location where the user desires to set up the game hub. This eliminates the need for establishing a direct communications link between the computer and game hub, such as a wired link or a wireless link. Thus, a virtual story could be created by a user in a computer at home, while the corresponding real world story is enacted using the game hub at a friend's house.

In accordance with another embodiment of the present invention, the system of FIG. 1 can be used for two-way construction of stories. For example, one or more of active physical game elements 108-116 can be configured to not only receive signals from game hub 106 but to also transmit signals thereto. Thus, at least one active physical game element is configured with sensors and/or controls that allow a user to perform an operation using the active game element, wherein information about the operation can be recorded by the active game element and sent to game hub 106 for storage in the storage device 104.

Accordingly, in a first path of a method for two-way construction of stories, a user can arrange and move one or more active physical toys in a real world scenario that is recorded and transmitted by storage device 104 to a website or software application for playing of a virtual version of the real world scenario.

In a second path of the method for two-way construction of stories, a website or self-contained software program is provided to a user for construction of a virtual story, which can be loaded to a game hub for operation of active physical toys in a real world scenario, as described above.

Furthermore, in accordance with an embodiment of the present invention, the two-way story construction method and system comprise a means for iterative building of a story. For example, a user can manipulate the active physical game elements to create a story or modify an existing story, and then transmit the story to a website or software application to play a virtual version of the story in the virtual world, which can be revised in the virtual world, and sent for further enactment and revisions in the physical world comprising the active physical game elements.

In one configuration of the present invention, hub 106 is provided with processors and/or software configured to send the user-created story information stored in drive 104 in an appropriate format to characters 108, 110, 112, 114, and 116. For example, the story information may call for a dragon to breathe fire. When the user creates an online story showing the dragon breathing fire, this action is stored as data that can be arranged in a format that can be used to command dragon toy 110 to simulate such an action. The information stored in drive 104 may include commands that cause dragon toy to “breathe fire,” for example, by lighting up. In addition, the information associated with breathing fire may command the dragon toy to make a sound, such as a roar associated with fire breathing. In one embodiment of the present invention, the hub 106 is configured with the capability to generate sounds, such that the hub may generate sound corresponding to certain actions of the active toys. Thus, dragon 110 may only be equipped with a light that is activated when a fire breathing action is called for. Simultaneously, the hub can activate a speaker that generates the roar of the dragon from the hub to coincide with the light activation in the dragon. Alternatively, certain active toys could also be equipped with sound generating capability.

In some cases, actions observed on-screen that are performed by a virtual object in the virtual story may not be replicated in a corresponding physical toy. Thus, while a dragon is seen to jump in the on-screen story, this action may be embodied in a corresponding toy as merely moving forward. Depending on the sophistication of the toy, the toy may have motors, controllers, and transducers that provide for varying ability to simulate the actions that are depicted in the cyberstory displayed on-screen. Accordingly, the active toys 108, 110, 112, 114, and 116 may embody the actions created in an online story by having additional, fewer, or somewhat different actions.

When drive 104 is placed in hub 106, the hub can be activated to send story information to toys (characters) 108, 110, 112, 114, and 116. Preferably, the information is uploaded to a communication chip and transmitted as an RF or infrared signal that can be received by active toys 108, 110, 112, 114, and 116 when the latter are in proximity to the hub 106. Hub 106 can be set to periodically attempt to detect signals that indicate the presence of characters 108, 110, 112, 114, and 116. Thus, for example, when a character is within radio range of hub 106, the hub is activated to send the story information to that character, which causes the character to perform a set of actions. In one variation of the present invention, the hub 104 is configured so that whenever a toy 108, 110, 112, 114, and 116 is first detected, the hub sends a signal to trigger the action for the corresponding character that is stored in the cyberstory.

Each of characters 108, 110, 112, 114, and 116 is equipped with an appropriate receiver to receive, for example, a radio signal and forward the radio signal to an appropriate processor or controller that then sends information from the signal to one or more active elements within the character (not shown). Characters 108, 110, 112, 114, and 116 may also be equipped with transmitters that can announce their presence to the hub 106. Thus, when all active toys are within communication range of the hub, the storyline can be acted out as a series of actions performed by the active toys in a sequence corresponding to the user-centered story.

In accordance with a user's desire, a user could selectively bring active toys 108, 110, 112, 114, and 116 within activation range in which the active toys can receive signals from hub 106. Thus, a stored storyline may involve a first series of actions. However, because a user manually places one or more of active toys 108, 110, 112, 114, and 116 outside of a range of hub 106, only a subset of the actions of the storyline are sent to or received by the active toys at a particular time, so that the actions in the virtual story are modified in the physical game according to the manual placement of characters by a user. If the hub is configured to trigger a toy action whenever the toy is first detected as coming within range, a toy can be repeatedly brought into and out of range to repeat actions that may only be prescribed once in the story line. In another example, a set of similar active toys, for example, a set of cannons, could be brought into proximity of the game hub in serial fashion, where each cannon is triggered to fire when detected by the game hub. Thus, embodiments of the present invention provide a means wherein a user can customize the play experience by creating a story online and using that story as a template for scenarios that can be modified in the corresponding physical game by manual intervention of the user.

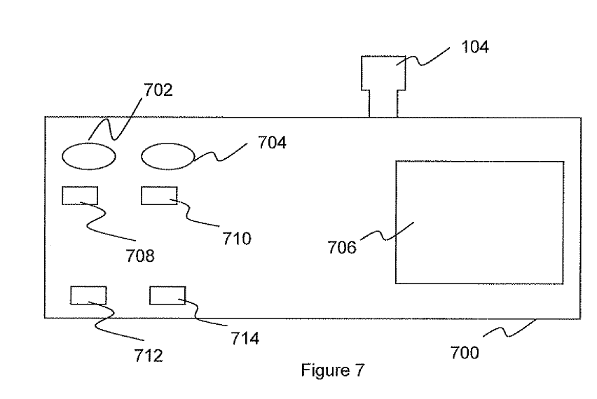

In an embodiment of the present invention depicted in FIG. 7, the game hub 700 includes a series of controls that facilitate acting out a scenario with the desired set of active toys. In accordance with one embodiment of the present invention, when a storyline is loaded in the game hub, for example, when a USB or other storage device 104 is inserted in the game hub, the game hub is enabled to send signals to the active toys by pressing a start button 702 provided on the game hub. Pressing of the start button 702 causes the hub to begin sending signals according to the set of actions stored in the storyline in the USB storage device. The signals can then be received and implemented by the appropriate active toys that are within communications range of the game hub. Because a scenario corresponding to the storyline stored in the USB storage device may involve a series of actions that are performed in sequence, the game hub can be configured to communicate the signals to various active toys according to the storyline sequence. Thus, after a start button is pressed, the game hub sends a first signal to a first active toy to perform a first set of actions. The game hub subsequently sends a second signal after a predetermined interval to a second active toy to perform a second set of actions, and so forth and so on.

In accordance with an embodiment of the present invention, the game hub is also provided with a stop button 704 that terminates transmission of signals from the game hub to active toys. Thus, a user may desire to stop a scenario after a dragon has breathed fire in order to reposition an active toy, such as a knight. The user presses the stop button 704, which causes the game hub to stop sending signals, so that signals corresponding to the storyline action of “knight fires weapon” are not sent to the knight toy. The user can then physically reposition the knight toy, press start, and watch as the game hub subsequently sends a signal to the knight, and the knight performs the action of firing a weapon.

In accordance with an embodiment of the present invention, the storage hub may include an LCD screen 706 or other display (not shown) that provides status information to a user, such as whether a storyline is loaded in the game hub, and whether signals are being sent to or received from the active toys.

The game hub can also include processors and/or software (not shown) that allow the virtual storyline to be shown locally on the game hub to facilitate play using active physical toys. For example, a storyline stored in storage device 104 when inserted in the game hub 700 can trigger game hub display 706 to illustrate a scene from the storyline, such as an initial scenario that depicts the relative position of active game elements, such as the position of knights and dragons with respect to a castle. Thus, a user could view the “castle” scenario depicted on screen 706, and position active toys around game hub 700 (which is configured to form part of a real toy castle) according to the arrangement depicted ion screen 706.

In further embodiments of the present invention, the game hub can be configured to receive storage devices such as CDs, DVDs, or similar storage devices. The game hub can include further controls, such as rewind 708, fast forward 710, etc., that allow a user to navigate through the storyline and display any desired portion of the storyline.

In accordance with another embodiment of the present invention, hub 700 is configured with a send button 712 that is configured to send signals when engaged to active toys in communications range of hub 700. Thus, in accordance with one embodiment of the present invention, if a user depresses a start or similar button, a processor in hub 700 begins playing the scenario loaded in the hub. If the send button 712 is not depressed, the storyline is displayed on screen 706, but the active toys perform no action. If both the start button and send button 712 are depressed, signals according to the storyline are sent to the active toys.

In accordance with another embodiment of the present invention, hub 700 is configured with a receive (or record) button 714 that is configured to receive signals when engaged from active toys in communications range of hub 700. Thus, in accordance with one embodiment of the present invention, if a user depresses a record button, a processor in hub 700 activates a receiver (not shown) in hub 700 that is configured to receive signals, such as wireless signals from active toys. The processor also triggers recording of the signals in hub 700 received from active toys. In accordance with an embodiment of the present invention, the hub 700 is configured to record the signals in a preconfigured storyline template. In one example, a user can be provided with a menu on screen 706 that allows the user to select the preconfigured storyline template, such as “medieval scenario,” which provides context for building a story based on signals received at hub 700 from active toys whose actions may be triggered by manipulation from a user. Thus, if the user triggers a physical knight toy to fire a weapon, that action is sent to the hub 700 for recording. By pressing receive button 714 a second time, the hub 700 stops receiving and recording signals received from active toys and a currently recording scenario is stored in the hub 700, either in a memory (not shown) local to the hub, or in a portable storage device inserted in the hub

Although embodiments disclosed above describe the use of a remotely accessed website 102, in an alternative embodiment, system 100 could use a computer software application locally installed on a computer. In this case, for example, a virtual story could be created using the local software application and stored on the drive 104, which would then be plugged into the hub 106.

Overall, the present invention enables a user to build her own story in her own world, combining the hands-on creative play experience of construction toys (e.g., stackable, interlocking blocks) with the immersive, content-rich world of the internet. The user can enter a virtual world where the user can create and control the landscape and everything in it, such as buildings, people, and creatures. The user can create the world and control the characters within the world to create a story. As such, the user can build the virtual world and then have an actual physical set of toys come alive to enact the fantasy story that the user has created online, complete with, for example, voice-over narration, sound effects, and real actions. The user can control the flow of the storyline in the real world play mode, for example, having the construction play pieces trigger actions at the appropriate times.

In one exemplary implementation, the virtual world and actual physical construction set could be a medieval historical fantasy featuring castles, kings, knights, creatures, and battle actions.

In one exemplary implementation, a user creates the story through a website accessed through codes found on products purchased at retail. Alternatively, the site could also be publicly accessible in a “read-only” format, unless a user has the code access. The site could include all the elements needed to build a virtual world and to create an actual storyline where these elements interact and play out designated roles. Users could, for example, choose and customize terrains, castles, kings, knights, armament, and creatures. Users could also create an avatar with powers and attributes they choose. Using the predefined story content, users could “write” their own fantasy storyline and have highlights from the story play out on their computer screens. The settings, characters, and storylines can be saved, traded to other members, or modified within an online community.

In one exemplary implementation, a drive (e.g., a USB flash drive) transfers the virtual story to a physical construction. The drive can be shaped as icons specific to a theme, such as swords, banners, shields, lances, or torches corresponding to a medieval theme. These drives can be collectible components and can be unique to themed construction sets. The drives can be configured to launch a particular website when plugged into a computer connected to the internet. The data for the customized buildings, characters, and storylines are stored on the drive, which is then plugged into the hub. The drives can also be configured with preloaded content such as sample storylines, television advertisements, alternate building instructions, or cross-sell messages for other products.

The hub accepts the drive and controls the interactive construction play experience. In one exemplary implementation of the present invention, the hub itself is a building component that can be integrated into all the toy construction sets within a particular product line. The hub can have recognition technology that identifies designated building set components, such as figures, creatures, castle parts, and weapons. When these components are brought into the field of play, proximity to the hub can trigger the action on the component (e.g., catapult firing or building collapsing) and simultaneously trigger the storyline outputs from the hub (e.g., voice and sound effects).

In an exemplary play pattern of the present invention, there are two basic play environments: the online virtual world found on the website and the three-dimensional physical world of the construction play sets. A significant aspect of the present invention is the joining of these two environments, which allow a child to completely customize and control the play experience. In particular, the child can customize a virtual world, create a unique story, share the virtual world and story with other children, and play out the story with actual physical builds.

In a further embodiment of the present invention, a user can manipulate the physical toys to create a story or modify an existing story, and then transmit the story to a website or software application to play a virtual version of the story in the virtual world. For example, an active physical toy could be configured with position sensors and programming controls that enable a user to manipulate the toy to perform an action, which is recorded by the toy and/or is transmitted by the toy to the hub, which records control signals for the action. The position sensors can sense the particular position and movement of the toy. The programming controls can provide means for the user to program discrete actions (e.g., a button to activate a light or sound). The hub and active toys would be configured for two-way communication to effect this programming mode. Thus, in this further embodiment, a user can build a physical model, manipulate the parts of the model to create a story, record the actions of the parts, and transfer (e.g., using the drive 104) the record actions and story to the virtual world for further enactment and revisions, as desired.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for providing an interactive story, comprising:
a storybuilder program operable to provide using a visual display a set of menu options of virtual toys and virtual toy actions and operable to receive selections of the menu options from authorized users and to display results of the selections as a virtual storyline, wherein the virtual storyline comprises a set of virtual toys arranged in one of a set of still images, a set of video portions, and a set of still images and video portions;
a portable drive configured to store the virtual storyline;
a set of active toys corresponding to the selected virtual toys; and
a game hub configured to receive the portable drive and send electromagnetic signals to each of the active toys within a communication range of the physical hub, the electromagnetic signals controlling the set of active toys to perform actions corresponding to the selected virtual toy actions of the respective selected virtual toys of the virtual storyline.

2. The system of claim 1, wherein the portable drive is configured to engage a device that is coupled to an internet website, wherein the website provides an interface for operation of the storybuilder program.

3. The system of claim 1, wherein the story builder program comprises a standalone program configured for storage in a local drive of a computer.

4. The system of claim 2, wherein the internet website comprises a set of vendor websites each designed according to a separate theme, wherein the system is configured to provide access to a website of the set of vendor websites in accordance with an access code entered by the user.

5. The system of claim 1, wherein the game hub comprises a construction element of a toy construction kit, wherein the game hub is configured to assemble together with additional parts.

6. The system of claim 5, wherein the toy construction kit comprises construction elements for building a castle, the game hub is configured to form a portion of the castle, and the active toys comprise one or more of knight action figures, dragon action figures, and cannons.

7. The system of claim 1, wherein the portable drive comprises a USB drive.

8. The system of claim 1, wherein the game hub is configured to send the electromagnetic signals over a wireless link.

9. A method for interactive play, comprising:
providing to a first user access to a storybuilder program through a computing device;
receiving a set of selections from the first user based on the storybuilder program, the set of selections designating actions performed by virtual toys in a storyline;
playing the storyline on the computing device for review by the first user;
storing the storyline in a portable storage device;
providing a set of active toys corresponding to one or more of the virtual toys; and
providing a game hub that is configured to receive the portable storage device, read the set of selections, and send signals to the set of active toys to activate each active toy to perform an action corresponding to an action of its respective virtual toy according to the storyline.

10. The method of claim 9, wherein the storybuilder program comprises a website that includes an interactive set of web pages.

11. The method of claim 9, wherein the portable storage device comprises a USB drive.

12. The method of claim 9, wherein the game hub is configured to detect the presence of an active physical toy when the active physical toy is within a communications range of the game hub, and wherein the game hub is configured to send a control signal to the active physical toy when the game hub detects the active physical toy.

13. The method of claim 9, wherein the game hub is configured to periodically wirelessly broadcast control signals corresponding to operation of virtual toys of a storyline when the portable storage device is placed in the game hub.

14. The method of claim 10, further comprising:
storing the storyline at a location accessible through a website; and
providing one of read-only and read-write access to the storyline to an authorized user different from the first user.

15. The method of claim 14, further comprising:
receiving a set of selections from the authorized user;
storing the set of selections in a modified storyline based upon the storyline provided to the authorized user; and
providing to the first user, through the website, read-write access to the modified storyline.

16. The method of claim 10, wherein the portable storage device is configured to launch the website when placed in the computing device.

17. The method of claim 9, wherein the storybuilder program comprises an avatar that is configured to receive a set of characteristics according to choices made by the first user.

18. The method of claim 9, further comprising:
enabling the game hub to receive signals from active toys;
receiving a signal from at least one active toy at the game hub, the signal corresponding to a set of actions performed by the at least one active toy; and
storing the at least one signal at the game hub in a form that provides the set of actions in a second storyline.

19. The method of claim 18, wherein the at least one active toy is configured with one or more of sensors and controls that allow a user to perform an operation using the at least one active toy.

20. The method of claim 18, further comprising:
playing the second storyline in a computing device;
revising the second storyline using the storybuilder program; and
sending the revised second storyline to the game hub for transmission to the active toys.

21. The method of claim 20, wherein the second storyline is based upon actions of the storyline, wherein the actions of the storyline are forwarded to the active toys for enactment before creation of the second storyline.

22. The method of claim 14, wherein the website provides a means for trading storylines created by authorized users.

23. A game hub configured for multi-mode play, comprising:
a base plate;
a set of construction blocks for building a construction on the baseplate, the construction blocks based on a play theme; and
a port in the game hub configured to receive a portable storage device, wherein the game hub is configured to play a storyline created at a computing device by a user and stored in the portable storage device, and wherein the game hub is configured to send electrical signals that direct a set of active toys within a communications range of the game hub to perform actions of the storyline.

24. The game hub of claim 23, wherein the base plate is configured to provide a base for construction of a plurality of different constructions that are each based upon a different toy set, wherein each toy set comprises a set of construction blocks, a set of active toys, and a portable storage device dedicated to a play theme.

25. The game hub of claim 24, wherein the portable storage device comprises a different device for each toy set.

26. The game hub of claim 24, wherein the portable storage device is configured to launch a website when placed in the computing device, wherein the website provides an interactive storybuilder program for creating the storyline.

27. The game hub of claim 23, further comprising:
a start button configured to begin playing a storyline when engaged;
a stop button configured to stop playing the storyline when engaged; and
a display configured to display the storyline.

28. The game hub of claim 27, further comprising:
a send button, wherein the game hub is configured to send the electrical signals to the set of active toys only after the send button is depressed.

29. The game hub of claim 23, further comprising a receive button, wherein, when the receive button is engaged, the game hub is configured to receive electrical signals from the set of active toys, and to store the set of active signals in a storyline template designed according to a theme contained in the portable storage device.
